(19) United States
(12) Patent Application Publication
(10) Pub. No.: US 2020/0141298 A1
(43) Pub. Date: May 7, 2020

(54) TANK FOR STORING A SOLUTION AND METHOD FOR MEASURING A VALUE IN SUCH A TANK

(71) Applicant: Plastic Omnium Advanced Innovation and Research, Bruxelles (BE)

(72) Inventors: Tae Kyung KIM, Troy, MI (US); Vincent GALINIER, Ferndale, MI (US)

(73) Assignee: Plastic Omnium Advanced Innovation and Research, Bruxelles (BE)

(21) Appl. No.: 16/628,192

(22) PCT Filed: Jul. 6, 2018
(86) PCT No.: PCT/EP2018/068435

§ 371 Date: Jan. 2, 2020

Related U.S. Application Data
(60) Provisional application No. 62/529,847, filed on Jul. 7, 2017.

(51) Int. Cl. F01N 3/20; G01F 23/296; F01N 11/00

(52) U.S. Cl. CPC F01N 3/2066; G01F 23/2962; F01N 11/00; F01N 2610/02; B60K 13/04; F01N 2610/148; F01N 2900/1814; F01N 2610/144; F01N 2610/1406

(57) ABSTRACT

The invention relates to a tank (1) for storing a solution preferably a urea solution, on a motor vehicle, the tank comprising: —a pump (2), —a surface (6,7) configured to receive or emit ultrasound waves adapted to be in contact with the solution, —a valve (3) connected to the pump (2) and configured to send an amount of the solution contained in the tank directly onto the surface (6,7).

The invention relates to a tank for storing a solution on a motor vehicle, preferably for storing an aqueous solution, more preferably for storing a urea solution. The invention also relates to a method for measuring a value in such a tank.

A sound-emitting sensor, also referred to as an ultrasound sensor, can be used in such a tank, for example to measure a filling level of the tank by distance determination. The document U.S. Pat. No. 8,943,812 discloses an ultrasound sensor placed in a tank below the liquid level and configured to measure the filling level through distance/time determination of sound wave and of an echo of the sound waves. According to this document, the ultrasound sensor can measure the filling level directly by sending the sound waves up to the filling level, or by sending the sound waves to a sound deflection device which is integrated in the sump.

In this kind of measuring system by ultrasound, problems of reliability of the measures may occur. It has been found that the presence of micro air bubbles take part in the reasons of such problems of reliability. Indeed, during sloshing movements, a filling operation or in case of temperature gradient, air can be introduced or released into the solution contained by the tank. Micro air bubbles can thus deposit on the sensor, particularly on a surface of the sensor which is configured to emit and/or receive ultrasounds, including a deflection surface which is configured to receive and transmit ultrasounds. This phenomenon can appear also by itself only with time. When micro air bubbles cover one or a plurality of such surfaces participating to the filling level measurement, the sound waves are impacted, for example they cannot go through the micro air bubbles and have to be derived from them. Thus, the sensor does not work correctly since no signal can be received or incorrect signals are received. This makes it impossible to determinate the filling level.

Therefore, the invention seeks to provide a tank wherein the reliability of an ultrasound sensor is improved.

It's accordingly an object of the invention to provide a tank for storing a solution preferably a urea solution, on a motor vehicle, the tank comprising:
a pump,
a surface configured to receive or emit ultrasound waves adapted to be in contact with the solution,
a valve connected to the pump and configured to send an amount of the solution contained in the tank directly onto the surface.

Said surface is substantially plane, and preferably plane. Particularly, it differs from an inner surface of a tube.

Thanks to this valve, an amount of the solution in the tank forms a flow or stream which is injected against the surface to be protected. The potential micro air bubbles can thus be removed easily. Moreover, the amount of the solution used to be sent onto the surface comes directly from the tank, which means no additional means needs to be used for sending any additional solution from outside. This makes it possible, with simple technical measures, to realize elimination of the micro air bubbles on an ultrasound emitting surface or/and receiving surface participating to a measurement of the solution. An improved ultrasound sensor performance is obtained and the measurement carried out by the sensor is more accurate and efficient. This may be particularly important for tank leak detection or for reduction of risk of manual operations.

The wording “directly” preferably means that the solution is sent onto the surface through a flow having a main direction which intersects said surface. Particularly, the flow main direction is not parallel to the surface or in the vicinity of the surface, it is intersecting the surface. It is possible to have such a flow main direction by using derivation or intermediate deflecting means, however it is preferred to have an injection nozzle orientated towards the surface, which makes the flushing more powerful and reliable. Furthermore, the surface adapted “to receive or emit ultrasounds waves” has to be understood as including a surface adapted to transmit or to reflect ultrasound waves. In other words, said surface can be an active surface emitting and/or receiving ultrasound waves, considered as a transducing surface, or a passive surface, which only reflects ultrasound waves in another direction or transmit ultrasound waves.
The solution is preferably an aqueous solution, for example water, more preferably a urea solution. The tank is particularly advantageous for storing an aqueous solution, and even more a water solution, since micro bubbles are more important in such solutions.

The invention may further comprise one or more of the following features, taken alone or in combination:
Said surface is an emitting or receiving surface of an ultrasound sensor. In other words, said surface is a surface of the ultrasound sensor, that is to say a transducing surface.
Said surface is an emitting and receiving surface of an ultrasound sensor, preferably of a transducing piezoelectric sensor.
Said surface is an ultrasonic reflector. Particularly, said ultrasonic reflector receives ultrasound waves from an ultrasound sensor in order to reflect them towards the inner surface of solution in the tank, and then receives back ultrasound waves after reflection on the inner surface of solution in order to reflect them to the ultrasound sensor for treatment of signal. Such an ultrasound reflector is usually used to measure the level of solution in the tank.
The tank comprises an injection nozzle adapted to send the solution onto the surface according to an injection axis, wherein the injection axis forms an angle with the surface which is greater than 0° and less than 180°. It should be understood here that the angle is distinct from 0) and 180°. Such an angle between the injection axis and the surface is required to make sure that the amount of the solution is sent directly onto the surface, the injection axis intersecting said surface. Furthermore, using an injection nozzle allows an injection of the amount of the solution coming from the valve to be configurable and more accurate.
The tank comprises a controller connected to the sensor and configured to detect an anomaly in a measure performed using the surface. Using a controller allows to send the amount of the solution onto the surface only when the ultrasound sensor is detected as malfunctioning, which makes the system more reactive and energy efficient. An “anomaly in a measure performed using the surface” means that the sensor receives wrong signal or doesn't receive any signal at all. The detection of an anomaly preferably includes a step of comparison of the performed measure with predefined measures or ranges of measures. The anomaly is asserted for example when the performed measure is out of the range. For example, in the case of an ultrasound sensor adapted to measure concentration of a urea-water solution for a motor vehicle exhaust-gas treatment, the solution concentration has to be 32.5% at room temperature (usually 20° C.) and the controller can detect an anomaly in a measure when an ultrasound sensor can measure a value with 20% deviation from the correct value.
The valve is an electro valve and the controller commands the opening of the valve. So, the valve opening can be commanded remotely depending on the controller. In this embodiment, the electro valve controls the fluid stream to the surface and the pump acts preferably on a constant speed. The electro valve can be a solenoid valve.
The valve is a passive valve system and the controller commands the speed of the pump. In this embodiment, the valve can be a double check valve, and the pump is preferably configured to produce at least two different pressures. For example, the pump can perform a first level of revolutions per minute (rpm) when no measurement issue is detected by the controller. A first check valve allows therefore the fluid to flow at a first pressure and the injection nozzle is off. When a measurement anomaly is detected, the pump can perform a second level of revolutions per minute (rpm) which makes a second check valve to allow the fluid to flow and the injector nozzle is on.
The valve is configured to send an amount of solution onto a plurality of surfaces configured to receive or emit ultrasound waves, the surfaces belonging to one or more ultrasound sensors. This is particularly interesting in that one system can be used to eliminate micro bubbles from several surfaces and check quality of several types of measures, like measures on concentration and of filling level.
The valve is configured to send an amount of solution onto a first and a second surfaces belonging to a sensor adapted to measure the concentration of the solution, and onto a third surface belonging to a sensor adapted to measure the liquid level in the tank. This configuration allows to optimize the means for checking quality of measures regarding the quantity and the quality of the solution in the tank. To measure the concentration of the solution, the first surface is preferably adapted to emit the waves and the second surface to reflect then back to the first surface.
The valve is connected to a flushing pipe having two fluid outlets, each outlet being configured to send an amount of solution onto at least one surface. Thus, two surfaces can be flushed simultaneously through direct injection, assuring an appropriate elimination of micro bubbles. For example, “T” shape fluid outlets can be used to send an amount of solution in two different directions.
The tank comprises two valves, each valve being configured to send an amount of solution onto at least one surface. Thus, several surfaces can be flushed simultaneously and it is also possible to adapt the flow depending on the surface, for example depending on the distance between a nozzle injection and the surface.
The pump is a pump configured to extract the solution out of the tank. According to this embodiment, the pumping function and the micro air bubbles removing function are carried out by the same pump, which is a very simple structure of the tank and a more economical system. Indeed, it is possible to have a system for elimination of micro bubbles without requiring an additional pump in the tank.

It is also an object of the invention to provide a method for measuring a value in a tank for storing a solution with ultrasound sensor, the method comprising a step of injection which is sending an amount of the solution contained in the tank directly onto a surface configured to receive or emit ultrasound waves for eliminating micro bubbles from the surface.

The invention may further comprise one or more of the following features, taken alone or in combination:
The method comprises the further step of carrying out a measurement after the step of injection, preferably within a period of time comprised between 1 and 5 seconds. Thus, an automatic flushing program can be used, ensuring that the measurement is always carried out just after all surfaces participating to the measurement have been cleaned and got rid of micro air bubbles.
The method comprises the step of controlling a measurement carried out by an ultrasound sensor comprising a surface configured to receive or emit ultrasound waves and comprising the step of injection only if an anomaly measurement is detected. With this step of controlling, a selective flushing program can be suggested. The amount of the solution is sent only when an anomaly measurement is detected, which makes the system more economical of energy and time and reduces use of devices.
The method comprises the step of commanding the opening of a valve for sending an amount of the solution contained in the tank directly onto the surface. So, the flow of liquid on the surface is not continuous; the quantity and flow of injected solution is commanded through the opening of the valve.
The method comprises the step of commanding the speed of a pump for sending an amount of the solution contained in the tank directly onto the surface. So, the flow of liquid on the surface is not continuous; the quantity and flow of injected solution is commanded through the change of speed of the pump.

The following description shows some of the characteristics of the tank. This description is based on figures, which include:

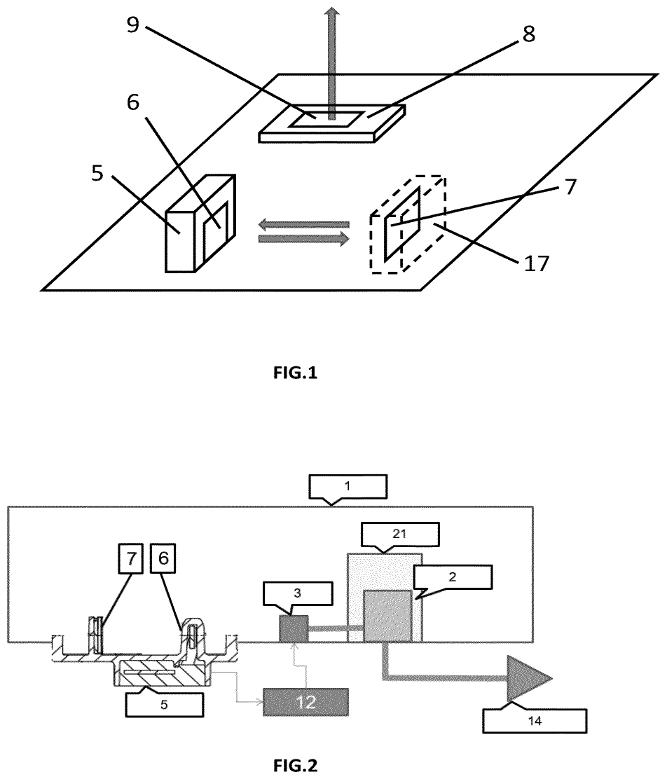

FIG. 1 illustrating a schematic perspective view of an example of sensors for a tank;

FIG. 2 illustrating a schematic view of a tank comprising an electro valve on closed position;

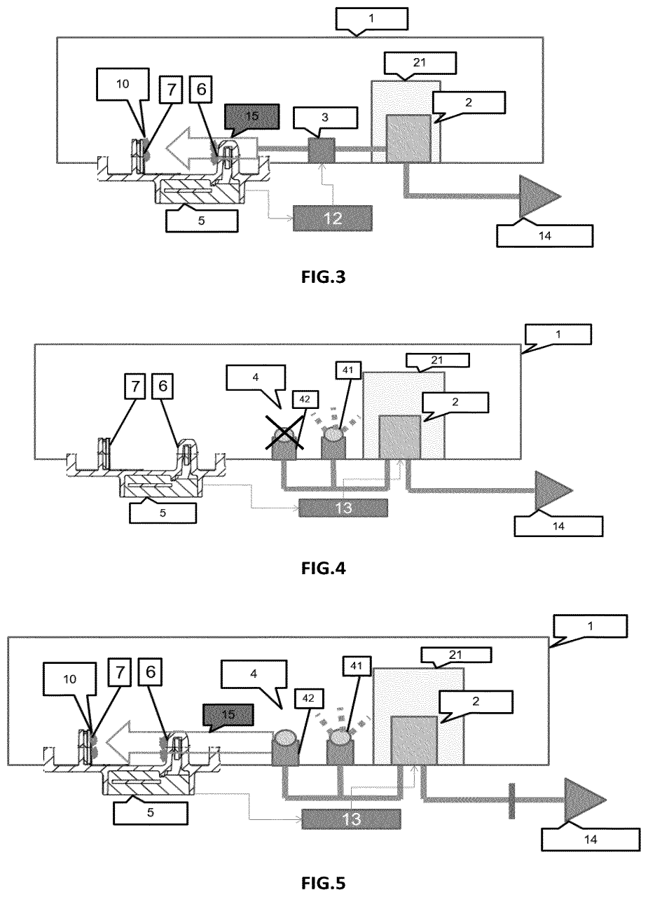

FIG. 3 illustrating a schematic view of the tank of FIG. 2, the electro valve being on opened position;

FIG. 4 illustrating a schematic view of a tank comprising a passive valve system on closed position;

FIG. 5 illustrating a schematic view of the tank of FIG. 4, the passive valve system being on opened position.

A tank for storing a solution on a motor vehicle, usually an aqueous solution, is designed by the reference 1 and is illustrated schematically in FIG. 2-5. The tank 1 defines an internal volume which is delimited by walls, and among these walls, a bottom. The tank 1 contains preferably a urea solution to be injected to an exhaust-gas treatment device of the vehicle. For this purpose, the tank 1 further comprises a pump 2 with which liquid can be extracted from the tank 1 at an intake point, the pump 2 being contained by a housing 21. The solution delivered by the pump 2 can be supplied through a first outlet line to an injector 14. The housing 21 can be inserted through an opening into the bottom of the tank 1.

The tank comprises one or a plurality of sensors 5, 8, which are preferably ultrasound sensors. For example and as schematically visible on FIG. 1, the tank comprises a first sensor 5 adapted to measure the concentration of the solution. The first ultrasound sensor 5 has a surface 6 which is substantially plane and is configured to emit ultrasound waves, called first surface 6. A diverter 17 is disposed next and face to the first sensor 5 and has a surface 7, called second surface 7, substantially plane and reflecting waves emitted by the first surface 6 in such a way that the waves pass back to the first surface 6. In other words, surface 6 is an active surface, or transducing surface. Surface 6 is here an emitting and receiving surface of the ultrasound sensor 5, which is for example a transducing piezoelectric sensor. Surface 7 is a passive surface, used to reflect the ultrasound waves. Thus, it is possible to perform a reference propagation time measurement by measuring the propagation time from the first surface 6 to the second surface 7 and back. The reference measurement can be used for determining the concentration of the solution in the tank. The tank 1 further comprises a second sensor 8 adapted to measure the liquid level in the tank 1. The second sensor 8 comprises a surface 9, called third surface 9, substantially plane configured to emit ultrasound waves towards a liquid surface of the solution in the tank and to receive the same waves coming from the liquid surface back to the sensor. The second sensor 8 is for example a transducing piezoelectric sensor. Surface 9 is thus an active surface. The propagation time measurement performed in this way can be used, together with the predetermined reference value, to determine the liquid level of the solution in the tank. All surfaces are adapted to be in contact with the solution to take the measurement.

The invention is not limited to the embodiment described above. Especially, it is possible to use only one sensor to determinate the concentration of the solution and/or the liquid level. For example, the sensor has a first surface which emits ultrasound waves towards the liquid surface for determining the liquid level and a diverter has second surface configured to reflect partially the waves to the first surface for determining the concentration. The first surface can be disposed in parallel to the bottom of the tank. The first surface can also be disposed in parallel to the other walls of the tank, in which case a reflector can be used to divert the waves from the sensor to the liquid surface. Furthermore, the sensor 5 to measure the concentration of the solution or the sensor 8 to measure the liquid level can vary. Particularly, they can use additional surfaces as reflecting surfaces, or else they can include a guiding or protective sheath, for example protruding perpendicularly from the sensor 8.

In a first embodiment of the tank and according to FIGS. 2 and 3, it comprises an electro valve 3, for example a solenoid valve 3. The electro valve 3 is connected to the pump 2 through a second outlet line and configured to send an amount of the solution contained in the tank directly onto the surface 7. The valve 3 can be connected to an injection nozzle which is adapted to send the solution onto the surface 7 according to an injection axis, wherein the injection axis forms an angle with the surface which is greater than 0° and less than 180°. Preferably, the angle is between 45° and 135°, more preferably about 90°, as show in FIG. 3, to achieve a very efficient elimination of micro air bubbles. A controller 12 is connected the solenoid valve 3 in order to command the opening of the valve 3. In this embodiment, the pump acts preferably on a constant speed so that the opening of the solenoid valves 3 allows the sending of amount of solution pumped through the intake point as illustrated in FIG. 3. The controller 12 is preferably also connected to the sensor 3 and configured to detect an anomaly in a measure performed using the surface 6 and 7. In this case the controller 12 commands the opening of the valve 3 only after the detection of the anomaly.

Similarly to the first embodiment and according to FIGS. 4 and 5, the tank comprises a passive valve, for example a double check valve comprising a first check valve 41 and a second check valve 42. A controller 13 is connected to and commands the pump 2 which, preferably, configured to have at least two different speeds. Theses speeds are expressed by level of rpm (revolution per minute) so we can talk about a first rpm which is «regular» rpm and a second rpm which is more important than the first rpm and called «high» rpm. As illustrated by FIG. 4, when the pump 2 runs at «regular» rpm, the pressure occurred by the pump 2 is suitable for the injector 14 for sending solution out of the tank, to the catalytic chamber for example, and the opening of the first check valve 41. However, this pressure is not enough for the opening of the second check valve 42 which needs a high pressure to open. As illustrated by FIG. 5, when the pump 2 runs at «high» rpm, the pressure occurred by the pump 2 increases and reaches a level which allows the opening of the second check valve 42 and the amount of solution can get through the same valve. When the pump 2 runs at «high» rpm, a valve device can be used between the pump 2 and the injector 14 and configured to stop the fluid from reaching the injector 14 as seen in FIG. 5. As same as for the first embodiment, the controller 13 is preferably connected to the sensor 3 and configured to detect an anomaly in a measure performed using the surface 6 and 7. In this manner, the controller 13 commands the opening of the valve 3 only after the detection of the anomaly.

In both of the described embodiments, the amount of solution is sent onto the surfaces directly, with a predetermined angle formed between the injection axis and each surface. For this purpose, each valve 3, 4 can be configured to send an amount of solution onto a plurality of surfaces 6, 7, 9 configured to receive or emit ultrasound waves, the surfaces 6, 7, 9 belonging to one or more ultrasound sensors 5, 8, i.e. two sensors here. For example, each valve can be connected to a flushing pipe having two fluid outlets, each outlet being configured to send an amount of solution onto at least one surface.

It is also possible to provide a tank comprising two independent valves, each valve being configured to send an amount of solution onto at least one surface.

In the described embodiments, the pump 2 is a pump configured to extract the solution out of the tank. But a second pump can be used only for sending solution towards the surfaces which runs independently to the pump 2 for sending solution to the injector 14.

The invention also relates as such to a method for measuring a value in a tank for storing a solution with ultrasound sensor, the method comprising a step of injection which is sending an amount of the solution contained in the tank directly onto a surface configured to receive or emit ultrasound waves for eliminating micro bubbles from the surface.

Advantageously, the method further comprises the step of carrying out a measurement after the step of injection within a period of time comprised between 1 and 5 seconds.

The above steps can perform in a repetitive way to provide an automatic flushing program which ensure that the measurement is always performed when all surfaces participating to the measurement are clean and without micro air bubbles.

In another embodiment, the method comprises the further step of controlling a measurement carried out by the ultrasound sensor 5 or 8 and the step of injection occurs only if an anomaly measurement is detected.

A controller is used in this embodiment in order to provide a selective flushing program wherein the amount of the solution is only sent when an anomaly measurement is detected.

In the case of an electro valve, the method comprises the further step of commanding the opening of a valve for sending an amount of the solution contained in the tank directly onto the surface. And in case of a passive valve, the method comprises a further step of commanding the speed of a pump for sending an amount of the solution contained in the tank directly onto the surface.

1. A tank for storing a solution on a motor vehicle, the tank comprising:
a pump;
a surface configured to receive or emit ultrasound waves adapted to be in contact with the solution, the surface being substantially plane; and
a valve connected to the pump and configured to send an amount of the solution comprised in the tank directly onto the surface.

2. The tank of claim 1, wherein the surface is an emitting or receiving surface of an ultrasound sensor.

3. The tank of claim 1, wherein the surface is an emitting and receiving surface of an ultrasound sensor.

4. The tank of claim 1, wherein the surface is an ultrasonic reflector.

5. The tank of claim 1, further comprising an injection nozzle adapted to send the solution onto the surface according to an injection axis, wherein the injection axis and the surface form an angle greater than 0° and less than 180°.

6. The tank of claim 1, further comprising a controller connected to the valve and configured to detect an anomaly in a measurement performed using the surface.

7. The tank of claim 6, wherein the valve is an electro valve and the controller commands an opening of the valve.

8. The tank of claim 6, wherein the valve is a passive valve system and the controller commands a speed of the pump.

9. The tank of claim 1, wherein the valve is configured to send an amount of the solution onto a plurality of surfaces configured to receive or emit ultrasound waves, the plurality of surfaces belonging to one or more ultrasound sensors.

10. The tank of claim 9, wherein the valve is configured to send an amount of the solution onto a first surface and a second surface, wherein the first surface and the second surface belong to a sensor adapted to measure a concentration of the solution, and onto a third surface belonging to a sensor adapted to measure a liquid level in the tank.

11. The tank of claim 9, wherein the valve is connected to a flushing pipe comprising two fluid outlets, each outlet being configured to send an amount of the solution onto at least one surface.

12. The tank of claim 9, wherein the tank comprises two valves, each valve being configured to send an amount of the solution onto at least one surface.

13. The tank of claim 1, wherein the pump is configured to extract the solution from the tank.

14. A method for measuring a value in a tank for storing a solution with an ultrasound sensor, the method comprising sending an amount of a solution comprised in the tank directly onto a surface configured to receive or emit ultrasound waves, to eliminate micro bubbles from the surface.

15. The method of claim 14, further comprising measuring a value after the sending.

16. The method of claim 14, further comprising controlling a measurement carried out by an ultrasound sensor comprising a surface configured to receive or emit ultrasound waves; and sending the amount of the solution only if an anomaly measurement is detected.

17. The method of claim 14, further comprising commanding an opening of a valve for sending an amount of the solution comprised in the tank directly onto the surface.

18. The method of claim 14, further comprising commanding a speed of a pump for sending an amount of the solution comprised in the tank directly onto the surface.
